(19) United States
(12) Patent Application Publication
(10) Pub. No.: US 2017/0042209 A1
(43) Pub. Date: Feb. 16, 2017

(54) COMPOSITION COMPRISING SACHA INCHI PROTEIN IN COMBINATION WITH OTHER PLANT PROTEINS

(71) Applicant: SHAKLEE CORPORATION, Pleasanton, CA (US)

(72) Inventors: Francis C. Lau, Pebble Beach, CA (US); Bruce P. Daggy, Pleasanton, CA (US); Emanuel P. Fakoukakis, Danville, CA (US)

(21) Appl. No.: 15/233,211

(22) Filed: Aug. 10, 2016

Related U.S. Application Data
(60) Provisional application No. 62/203,564, filed on Aug. 11, 2015.

(51) Int. Cl. A23L 33/185; A23L 2/66; A23L 33/00

(52) U.S. Cl. CPC A23L 33/185; A23L 33/30; A23L 2/66; A23V 2002/00

(57) ABSTRACT

The present invention is directed to a high quality protein composition comprising Sacha inchi protein, pea protein, rice protein and potato protein.

### CROSS-REFERENCE TO RELATED APPLICATIONS

This application claims the benefit of U.S. Provisional Application No. 62/203,564, entitled “Composition Comprising Sacha Inchi Protein In Combination With Other Plant Proteins”, filed Aug. 11, 2015, the disclosure of which is hereby incorporated herein by reference in its entirety.

### BACKGROUND OF THE INVENTION

The present invention is directed to a high quality plant-based non-soy protein blend. Many people partially or wholly adopt a vegetarian diet for a variety of health and ethical reasons. Because the protein intake in vegetarian diets can be lower than meat-based diets it is important that a sufficient amount and variety of proteins be consumed to maintain a healthy metabolism. The particular amino acid content of proteins is important because of the need for sufficient amounts of the essential amino acids which cannot be produced by the human body. The nine essential amino acids include phenylalanine, valine, threonine tryptophan, methionine, leucine, isoleucine, lysine and histidine. Six other amino acids are considered conditionally essential in the human diet because their synthesis can be limited. These are arginine, cysteine, glycine, glutamine, proline and tyrosine.

The Protein Digestibility Corrected Amino Acid Score (PDCAAS) is a method recognized by the US Food and Drug Administration and the World Health Organization for evaluating the protein quality of different foods and food ingredients based on the amino acid requirements of humans and the ability of humans to digest those foods and food ingredients to effectively make use of the amino acid content. Foods are evaluated on a scale of 0 to 1 with 1 being the highest. While compositions can have protein qualities in excess of 1.00 standard practice is to truncate the score to 1.00.

Determination of PDCAAS is as follows: PDCAAS (%)=(mg of limiting amino acid in 1 g of test protein*/mg of same amino acid in 1 g of reference proteint)×fecal true digestibility percentage*

*PDCAAS for the blend, take the weighted average of IAA of each protein to determine the limiting AA and the weighted average of digestibility percentage of each protein and substitute these numbers in the above equation.

| †Essential Amino Acid | mg/g of Protein |
|---|---|
| Histidine | 18 |
| Isoleucine | 25 |
| Leucine | 55 |
| Lysine | 51 |
| Methionine + Cystine | 25 |
| Phenylalanine + Tyrosine | 47 |
| Threonine | 27 |
| Tryptophan | 7 |
| Valine | 32 |

¹IOM, Dietary REFERENCE INTAKES FOR Energy, Carbohydrate, Fiber, Fat, Fatty Acids, Cholesterol, Protein, and Amino Acids, 2005, Page 688-9.

The Institute of Medicine (TOM) is a division of the National Academies of Sciences, Engineering, and Medicine. The Academies are private, nonprofit institutions founded in 1970 that provide independent, objective analysis and advice to the nation to solve complex problems and inform public policy decisions related to science, technology, and medicine. The Academies operate under an 1863 congressional charter to the National Academy of Sciences, signed by President Lincoln. (http://iom.nationalacademies.org/About-IOM.aspx; accessed August, 2015). IOM is now known as the National Academy of Medicine effective Jul. 1, 2015.

IOM develops the Dietary Reference Intake (DRI) system of nutrition recommendations. This system is used by both the United States and Canada and is intended for the general public and health professionals. Applications include: Composition of diets for schools, prisons, hospitals or nursing homes; Industries developing new food stuffs; and Healthcare policy makers and public health officials.

Animal based proteins such as casein, whey and egg white score 1.00 on the PDCAAS scale with plant based proteins typically having lower scores. For example, whole wheat has a score of 0.42 and legumes, fruits and vegetables having scores ranging from about 0.70 to 0.78.

Soy protein with a PDCAAS score of close to1.00 has a particularly high protein quality but some consumers prefer to avoid consumption of soy because of various reasons including allergies. Accordingly there exists a desire in the art for high quality plant-based protein compositions which are not soy based.

Of interest to the present invention is a perennial crop grown in the Amazon that his harvested every 15 to 20 days known as Sacha inchi or Inca Peanut (Plukenetia volubilis). The plant is traditionally harvested for seed oil. Of particular interest to the present invention is protein powder produced during the seed oil production from the Sacha inchi seeds. The resulting powder is said to be allergen free with a mild nutty taste and contains Omega 3, 6, and 9 fatty acids as well as vitamins and minerals such as calcium, magnesium phosphorus and potassium. See Sathe et al., J. Agric. Food Chem. 50, 4906-4908 (2002). Sacha inchi protein contains all nine essential amino acids for humans.

### BRIEF SUMMARY OF THE INVENTION

The present invention is directed to a high quality plant-based non-soy protein blend. In particular, the invention provides a composition for use as meal replacement comprising administering to a subject a composition comprising Sacha inchi protein, pea protein, rice protein and potato protein in an amount effective to maintain promote satiety, healthy body weight and lean body mass.

According to one aspect of the invention the composition comprises from 0.1 to 40 g of Sacha inchi protein with from 1 to 30 grams being preferred and with 2 to 20 grams and from 5 to 10 grams being particularly preferred. The Sacha inchi protein is obtained in the course of oil production and is commercially available from several Peruvian sources.

The composition further comprises from 0.1 to 40 g of pea protein with from 1 to 30 grams being preferred and with 2 to 20 grams and from 5 to 10 grams being particularly preferred. Pea protein is readily commercially available from a variety of sources.

The composition further comprises from 0.1 to 40 g of rice protein with from 1 to 30 grams being preferred and with 2 to 20 grams and from 5 to 10 grams being particularly preferred. Rice protein is readily commercially available from a variety of sources.

The composition further comprises from 0.1 to 40 g of potato protein with from 1 to 30 grams being preferred and with 2 to 20 grams and from 5 to 10 grams being particularly preferred. Potato protein is readily commercially available from a variety of sources.

The Sacha inchi, pea, rice and potato proteins may be combined in various ratios but are preferably combined in a manner to provide a very high quality protein product as measured by the PDCAAS method. Thus, the composition is desired to have a PDCAAS protein quality of 0.95 or greater with a quality of 0.98 or greater being preferred and a quality of 1.00 or greater being most preferred. Those of ordinary skill would be able to determine different ratios of the four component proteins but in general it is desired that Sacha inchi protein and pea protein comprise 70% or greater of the composition with a PDCAAS protein quality score of 1.00 or greater. In addition to providing a very high protein quality the compositions provide high levels of omega-3 fatty acid and alpha-linolenic acid (ALA).

The compositions of the invention can exist in a variety of forms to be consumed by humans including as a component in non-beverage food, a beverage, a liquid or a solid dietary supplement. Consumption of the compositions of the invention is particularly suitable for promoting maintenance of healthy body weight while maintaining lean body mass in human subjects.

According to one aspect of the invention the composition is provided as a meal replacement and a particularly preferable form is as a beverage such as a shake. Such meal replacements typically comprise other ingredients including vitamins, minerals, carbohydrates, fats and flavoring agents and can be prepared by the addition of other food ingredients including fruits, nuts and dairy components including whole and skim milk and yogurt. Ordinary consumers would be expected to consume the protein product of the invention in any of a variety of ways and in combination with a variety of ingredients.

According to another aspect of the invention a method is provided for controlling postprandial glycemic response in a mammal comprising the step of feeding the mammal a composition comprising Sacha inchi protein, pea protein, rice protein and potato protein.

According to one aspect of the invention the composition comprises from 0.1 to 40 g of Sacha inchi protein with from 1 to 30 grams being preferred and with 2 to 20 grams and from 5 to 10 grams being particularly preferred. The Sacha inchi protein is obtained in the course of oil production and is commercially available from several Peruvian sources.

The composition further comprises from 0.1 to 40 g of pea protein with from 1 to 30 grams being preferred and with 2 to 20 grams and from 5 to 10 grams being particularly preferred. Pea protein is readily commercially available from a variety of sources.

The composition further comprises from 0.1 to 40 g of rice protein with from 1 to 30 grams being preferred and with 2 to 20 grams and from 5 to 10 grams being particularly preferred. Rice protein is readily commercially available from a variety of sources.

The composition further comprises from 0.1 to 40 g of potato protein with from 1 to 30 grams being preferred and with 2 to 20 grams and from 5 to 10 grams being particularly preferred. Potato protein is readily commercially available from a variety of sources.

The Sacha inchi, pea, rice and potato proteins may be combined in various ratios but are preferably combined in a manner to provide a very high quality protein product as measured by the PDCAAS method. Thus, the composition is desired to have a PDCAAS protein quality of 0.95 or greater with a quality of 0.98 or greater being preferred and a quality of 1.00 or greater being most preferred. Those of ordinary skill would be able to determine different ratios of the four component proteins but in general it is desired that Sacha inchi protein and pea protein comprise 70% or greater of the composition with a PDCAAS protein quality score of 1.00 or greater. In addition to providing a very high protein quality the compositions provide high levels of omega-3 fatty acid and alpha-linolenic acid (ALA).

This application incorporates by reference the disclosure of co-owned and copending U.S. Ser. No. ______ filed Aug. 10, 2016 (Docket No. 32550/49927A) which claims benefit of Provisional Application Ser. No. 62/203,566 filed Aug. 11, 2015 the disclosure of which is also incorporated by reference.

### BRIEF DESCRIPTION OF THE DRAWING

FIG. 1 depicts the average plasma glucose response curves for the equal-carbohydrate portions of the reference food and the three protein products, shown as the change in plasma glucose from the fasting baseline level.

### DETAILED DESCRIPTION OF THE INVENTION

The invention provides a plant-based non-soy protein blend with particularly high quality. Specifically, the combination of Sacha inchi, pea, rice and potato proteins complement each other in terms of amino acid profile. Since PDCAAS is calculated based on limiting IAA, adding these proteins at different ratios may increase the value of limiting IAA thereby increasing PDCAAS as indicated in the equation. Sacha inchi, although containing complete protein, has a low PDCAAS (about 0.77) compared to potato protein (about 0.95). By combining these proteins and adjusting the ratio, it is possible to generate a blend that has a PDCAAS of 1.0. It is particularly desired to provide a blend that delivers high amount of leucine while maintaining a 1.0 PDCAAS. Organoleptic, texture and consistency characteristics of the resulting shake mixes are also important and dictate the ratio of each protein in the blend. The essential amino acid contents of the different protein components of the blend are set out in Table 1 below:

TABLE 1

| | Sacha Inchi | Potato Protein | Pea Protein | Rice Protein |
|---|---|---|---|---|
| | (mg/g | (mg/g | (mg/g | (mg/g |
| Amino Acid | protein) | protein) | protein) | protein) |
| Histidine | 23 | 18 | 25 | 22 |
| Isoleucine | 43 | 59 | 45 | 58 |
| Leucine | 63 | 98 | 84 | 91 |
| Lysine | 41 | 76 | 72 | 51 |
| Met + Cys | 27 | 35 | 21 | 47 |
| Phe + Tyr | 70 | 125 | 93 | 85 |
| Threonine | 41 | 47 | 39 | 48 |
| Tryptophan | 30 | 15 | 10 | 16 |
| Valine | 52 | 86 | 50 | 60 |

Particularly useful combinations according to the invention are provided below with the amount of protein in each serving being about 16 grams. According to one embodiment of the invention 16 grams of protein powder is blended with 8 ounces of non-fat milk thus providing about 24 grams of total protein per serving which provides about one-third the normal daily requirement for protein. Various alternative formulas according to the invention are presented below.

Formula 1

| Protein source | Protein (g) | % protein |
|---|---|---|
| Sacha inchi | 6.5 | 42.0 |
| Pea | 7.0 | 45.0 |
| Rice | 1.0 | 6.5 |
| Potato | 1.0 | 6.5 |
| Serving size (g) | 15.5 | 100.0 |
| % Leucine | 7.67 | |
| PDCAAS | 0.973 | |

Formula 2

| Protein source | Protein (g) | % protein |
|---|---|---|
| Sacha inchi | 5.5 | 35.5 |
| Pea | 8.0 | 51.6 |
| Rice | 1.0 | 6.4 |
| Potato | 1.0 | 6.5 |
| Serving size (g) | 15.5 | 100.0 |
| % Leucine | 7.81 | |
| PDCAAS | 0.950 | |

Formula 3

| Protein source | Protein (g) | % protein |
|---|---|---|
| Sacha inchi | 4.6 | 30.0 |
| Pea | 6.7 | 43.0 |
| Rice | 0.4 | 2.5 |
| Potato | 3.8 | 24.5 |
| Serving size (g) | 15.5 | 100.0 |
| % Leucine | 8.15 | |
| PDCAAS | 1.002 | |

Explanation of Terms

“Administering” a dosage or dosage form or an amount includes self-administration by the subject, administration by another to the subject, and providing advice for administration to the subject (as in instructions provided in a tangible medium, such as printed instructions or advice on a computer readable medium). Administration by another to the subject can include, for example, administration by a physician, nurse or other health care provider or dietary consultant. Administration also includes providing an end product (such as a mixed beverage) that is consumed, or precursors that contain the end product (such as a powdered mix to be dispensed in a beverage) that another (such as the subject) may prepare for consumption.

Amounts expressed herein as percentages are percentages by weight unless indicated otherwise.

Ingredients can be “distributed into more than one dosage form,” meaning that one ingredient (such as Sacha inchi protein) may be administered in different dosage forms (for example in both a shake mix and snack).

A “dosage form” comprises any preparation, or combination of preparations, that provides a desired dosage. Hence a dosage form can include a single composition (such as a powdered beverage mix or other ingestible preparation) or a combination of several different compositions (such as a powdered beverage mix, a snack and a supplement). A dosage form can “provide a daily dosage” in either a single unit dosage form (such as a tablet or a liquid beverage in which the powder mix is dispensed) or in multiple dosages taken at different times throughout a day. Hence a dosage form that includes multiple sub-dosage forms can provide the total daily dosage administered at different times during a day (for example at breakfast and lunch), and in different forms (for example as a liquid beverage and a chewable snack bar). A particular example of a dosage form is an artificial preparation that includes a pharmaceutical carrier. A further distinction can be drawn between an exogenous preparation and a food preparation, wherein an exogenous preparation is in addition to consumed conventional food.

As used herein, the terms “individual” or “subject” refer to an animal, such as a mammal, for example a human.

A “shake mix” or “drink mix” or “beverage mix” refers to a mixture, such as a powdered mixture, that is suitable for mixing in a liquid base (such as water or milk) to provide a beverage in which the mixture is dispensed to a subject. The shake mixture increases the thickness of the liquid base.

A “snack” refers to an edible solid having at least some organoleptic properties consistent with food. Examples of a snack include a snack bar (similar in appearance and mouth feel to a chewable candy bar), and a solid snack (more similar in appearance and mouth feel to a hard candy).

A “supplement” refers to a non-food form of dosage administration other than the liquid beverage or a solid snack. An example of a supplement is a pharmaceutical preparation (such as a tablet, enteral liquid, parenteral liquid, capsule, intranasal liquid or other form). In a particular disclosed example the supplement is a pharmaceutical preparation, in particular a tablet or capsule.

“Supplemental food” refers to food that is provided in addition to the drink mixture, snack, supplement and tea.

In certain embodiments, the shake mix, snack and supplement are an exogenous preparation that is administered or consumed in addition to food preparations such as the prescribed diet and supplemental food.

The other above noted criteria are evaluated by any reliable means, such as those conventionally used in medical examinations.

A particularly advantageous embodiment breaks the dosage form into multiple dosage forms, wherein the protein components are each distributed into more than one dosage form such as a drink mix, a consumable snack, and a supplement. For example, the dosage forms can include a drink mix that provides a daily dosage of 20 g Sacha inchi protein, 25 g pea protein; 5 g rice protein and 10 g of potato protein; a consumable snack (such as a snack bar) that provides a daily dosage of 60 g and a supplement (such as an ingestible capsule or tablet) (for example distributed into three separate tablets that can be ingested at different times throughout the day to deliver equal separate doses of the proteins that aggregate to the daily dose.

In particular examples, the dosage forms are administered in a pattern consistent with social norms for daily nutritional intake. For example, the drink mix is divided into two dosage units that substantially equally divide the daily dosage between the two units, for example two drink (such as shake) servings per day that substitute for two different meals (such as breakfast and lunch, or breakfast and dinner, or any other combination of two meals). In certain specific examples, the dosage form is made up of three component dosage forms, such as a drink mix administered in a liquid base twice a day (abbreviated “bid”), a snack consumed once a day, and a supplement consumed once, twice or three times a day, wherein the dosages provided by the dosage form are distributed as follows and provide the indicated daily totals.

The method may also include providing no more than one full meal a day, although supplemental food may also be consumed. The additional food can be selected to maintain a particular daily consumption of calories, with the goal of maintaining the subject in a condition of a caloric deficit with respect to calories consumed and energy expended. Providing a meal and/or supplemental food includes (without limitation) either advising consumption of it or actually dispensing it (as in a prepackaged form). A meal or the supplemental food could be, for example, a dinner that does not include any of the beverage, snack, supplement or tea. In some embodiments supplemental food may be administered by itself or together with the snack depending on the caloric requirements of the individual.

Meals and supplemental foods are designed to be well-balanced and include nutritious food choices from a variety of food groups such as meat, fruit, vegetables, breads and cereals and fats. When the meals and/or supplemental foods are consumed with certain embodiments of the method (such as the powdered beverage mix and snack) as part of a total weight loss program, they may provide a macronutrient balanced diet with approximately 40%-45% of calories coming from carbohydrate, 25-30% of calories coming from protein and 25-30% of calories from fat. The source of carbohydrates provided in the meals and snacks is primarily from complex carbohydrates (whole grain breads and starches, fresh fruits and vegetables) which are good sources of dietary fiber and tend to have a low glycemic index. Protein food choices are from leaner cuts of meats, chicken, turkey and fish and the fat content in the meals tends to come from monounsaturated fats (i.e. olive and canola oils) so as to limit intakes of saturated and trans fats whenever possible. Meals and supplemental food are incorporated into a range of calorie levels (1200, 1500, 1800 and 2100) and several variations including no dairy, no red meat and lacto-ovo vegetarian meal plans.

The Sacha inchi, pea, rice and potato protein compositions can be included in a weight loss kit that includes the dosage forms described above, in combination with instructions for its use to lose weight while preserving lean body mass. Particular embodiments of the kit provide instructions for consuming the components of the kit (such as the powder, snack, tea, multivitamins and other supplements) in a manner that provides the desired dosages of the various components in a manner that enhances their effect of losing weight while preserving lean body mass.

### EXAMPLE 1

According to this example, a high quality plant-based non-soy protein blend containing Sacha inchi is compared to a conventional soy-based protein blend in a trial including males and females between the ages of 30 and 69 in which about 16 ounces of the protein powder compositions described in Formulas 1, 2 and 3 above are mixed with 8 ounces of fat free milk to produce a shake comprising 24 grams of protein per serving which is about one-third of the daily protein requirement. A control leg is also run wherein a conventional soy-based protein blend is consumed. The test subjects also consume multi-vitamins, fish oil supplements, vitamin B and C supplements and capsules of a polyphenol-enriched supplement along with a blend of prebiotics and probiotics. Women over 50 years of age and all men receive a multivitamin without iron while women under 50 years of age or pregnant receive a multivitamin including iron.

The composition is compared with the prior art soy-based composition for qualities such as digestibility, bloating, gas formation and the like. The composition is also compared with the prior art soy-based composition for measures such as satiety, overall metabolism, weight maintenance, weight loss and the like.

### EXAMPLE 2

According to this example, a 30-day home use test was conducted using adult volunteers between the ages of 25 and 69 who are irregular users of supplements/multi-vitamins but not regular/heavy users of supplement products. Participants who did not believe that supplements had any benefit at all were excluded as were participants who were pregnant/nursing or had allergies to the supplement product.

Participants were instructed to take one multi-vitamin/phytonutrient supplement plus either 1) one soy protein shake according to the invention or 2) one non-soy protein shake according to the invention to replace one meal for 30 days. The shakes had the same nutritional profiles except for the source of protein: soy-based and non-soy plant-based protein.

The participants were instructed to keep a diary everyday and enter the diary information once a week to the researchers make sure that they were using the test products. All participants were called after three days to determine if there were any digestive problems/issues. The participants were called midway through the study to remind them to complete the self-administered online questionnaire after three weeks and 30 days. The questionnaire contained a series of quality of life questions with answers in a 4-point scale of agreement format (Strongly Agree [4], Agree [3], Disagree [2], Strongly Disagree [1]). The results of the top two box scores (Strongly Agree and Agree) were used to indicated consumer acceptance of the nutrition programs.

Results: Participants in the non-soy group reported more favorable experience than those in the soy-group in the top 5 questions after 30 days of using this nutrition program (Table 2).

TABLE 2
Top two box responses (Strongly Agree and Agree)
to the top 5 quality of life statements

| | Soy | Non-Soy |
|---|---|---|
| Statements | (% responses) | (% responses) |
| 1. Feeling better | 84 | 84 |
| 2. Feeling energized | 79 | 79 |
| 3. Feeling healthier | 83 | 87 |
| 4. Feeling more vitality | 79 | 80 |
| 5. Feeling overall feeling of well-being | 85 | 86 |

### EXAMPLE 3

### Effect on Glycemic Index of Subjects After Dietary Supplementation with Protein Compositions

According to this example, a non-soy protein blend according to the invention further including a probiotic and prebiotic composition (Bacillus coagulans and pre-biotic fibers (a plant-based fiber, a resistant starch and a short-chain oligosaccharide) and a soy protein based formula not according to the invention were tested to determine their effects on the glycemic index (GI) when present in nutrient shakes. The glycemic index is a number associated with a particular type of food that indicates the food's effect on a person's blood glucose (sugar) level. The GI represents the total rise in a person's blood sugar level following consumption of the food. Also tested was a soy protein based shake not according to the invention.

Testing was carried out using internationally recognized GI methodology (Joint FAO/WHO Report. Carbohydrates in Human Nutrition. FAO Food and Nutrition, Paper 66. Rome: FAO, 1998.), which has been validated by results obtained from small experimental studies and large multi-center research trials (Wolever T M S et al. Determination of the glycemic index values of foods: an interlaboratory study. European Journal of Clinical Nutrition 2003; 57: 475-482). The experimental procedures used in this study were in accordance with international standards for conducting ethical research with humans and were approved by the Medical Ethics Review Committee of Sydney University.

A group of ten healthy, non-smoking people, aged between 18-65 years, was recruited from the staff and student population of the University of Sydney. (A power-based (90%) sample size calculation using data from many published GI studies indicated that a group of at least 10 people would be needed for this study in order to find a significant difference among the GI values of the test foods and the reference food, if a significant difference truly exists (a difference of 1.0 standard deviation units in GI.)) People volunteering to participate in the study were excluded if they: were over- or underweight; were dieting; had impaired glucose tolerance; were suffering from any illness or food allergy; or were regularly taking prescription medication other than standard contraceptive medication. The group that participated in the study consisted of six females and four males. The average age of the subjects was 26.4 years (range: 19.9-34.8 years) and the group's average body mass index (BMI) score was 21.2 kg/m2 (range: 19.4-24.7 kg/m2). The BMI score is a measure of a person's weight in relation to their height. BMI values between 18-25.0 kg/m2 are within the healthy weight range.

Test Foods

Glucose (reference food)

Nutrient Shake, Soy (vanilla)—shaker preparation

Nutrient Shake, Non-Soy (vanilla)—shaker preparation

Nutrient Shake, Non-Soy (vanilla)—blender preparation

According to this example, prebiotic components of a resistant starch dextrin which is partially hydrolyzed maize and is commercially available from Roquette, Keokuk, IA as FM06, a short chain oligosaccharide is a β2-1 linked liner chain of fructose bound to a terminal glucose commercially available as Nutraflora® available from Ingredion, Westchester, IL and a probiotic comprising at least 1 billion viable CFU of Bacillus coagulans GBI-30 were incorporated into soy and non-soy nutrient shakes which further contained plant-based dietary fiber in the amounts presented in Table 3 below. In the case of the soy nutrient shake the fiber was primarily soy fiber which naturally accompanied the extracted soy protein. In the case of the non-soy shake the fiber was primarily fiber which accompanied pea protein and Sacha inchi protein present in the shake composition. The shakes contained other protein, carbohydrates, fats, vitamins and other nutrients with the calorie counts and other nutritional information set out in Table 4 below. In each case, the amount of fiber totals to 6 grams per serving.

TABLE 3
Fiber Components -6 grams per serving

| | Dextrin | SC FOS | Other Fiber | BC₃₀ |
|---|---|---|---|---|
| Shake | (g) | (g) | (g) | (CFU) |
| Soy Vanilla | 3.0 | 1.2 | 1.8 | 1 billion |
| Non-Soy Vanilla | 4.1 | 1.2 | 0.7 | 1 billion |

TABLE 4
The weights and carbohydrate contents of the test portions of the reference
food and the three shakes, calculated using manufacturers' data.

| | | | | | Available | | |
|---|---|---|---|---|---|---|---|
| | Portion | Energy | Protein | Fat | Carbohydrate | Sugar | Fiber |
| Test food | Size (g) | (kJ) | (g) | (g) | (g) | (g) | (g) |
| Reference food | 25.7 g glucose | 400 | 0.0 | 0.0 | 25.0 | 25.0 | 0.0 |
| (glucose sugar) | 250 mL water | | | | | | |
| Soy Life Shake | 89.6 g powder | 1481 | 33.3 | 6.3 | 25.0 | 20.8 | 12.5 |
| | 520.8 mL water | | | | | | |
| Non-Soy Life | 93.8 g powder | 1481 | 33.4 | 6.3 | 25.0 | 20.8 | 12.5 |
| Shake-shaker | 521.1 mL water | | | | | | |
| Non-Soy Life | 93.8 g powder | 1481 | 33.4 | 6.3 | 25.0 | 20.8 | 12.5 |
| Shake-blender | 521.1 mL water | | | | | | |

Each test portion of the nutrient shakes was prepared according to the manufacturer's instructions immediately before required. For the two shakes that were prepared using the shaker method, the appropriate amount of powder and cold water were placed into a plastic shaker container and mixed well by manual shaking for 1 minute until combined. For the shake that was prepared using the blender method, the appropriate amount of powder and cold water were placed into blender and mixed well for 20 seconds until combined. Each prepared shake was served to a subject with 250 mL of plain water. The subjects were required to consume all fluid served.

Using standard methodology to determine a food's GI value, a portion of the food containing between 25 and 50 grams of available carbohydrate was fed to the group of ten healthy people the morning after they have fasted overnight. A fasting blood sample was obtained and then the food was consumed, after which additional blood samples were obtained at regular intervals during the next two hours. In this way, it was possible to measure the total increase in blood sugar (glucose) produced by that food over a two-hour period.

The same procedure was repeated in the same group of people on another day after they have consumed a portion of the reference food (pure glucose sugar in water) containing an equal amount of available carbohydrate. A GI value for the test food can then be calculated by expressing the two-hour blood glucose response to the test food as a percentage of the response produced by the reference food (GI value of glucose=100). Therefore, GI values for foods are relative measures which indicate how high blood sugar levels rise after eating a particular food compared to the very high blood sugar response produced by the same amount of carbohydrate in the form of glucose sugar. Equal-carbohydrate portions of the test foods and reference food are used in GI studies, because carbohydrate is the nutrient in food that directly causes the blood's glucose level to rise.

In this study, the ten healthy people each consumed the reference food on three separate occasions and each of the test foods on one occasion only. Therefore, subjects completed six test sessions. The reference food was consumed on the first, fourth and sixth test sessions, and the test foods were consumed in random order in between. Each session was completed on a separate morning with at least a day in between subsequent sessions.

For each subject, the concentration of glucose in the plasma component of each of the eight plasma samples collected during each two-hour test session was analyzed in duplicates. A two-hour blood glucose response curve was constructed for each subject's reference food and test food sessions using the average plasma glucose concentrations for each of their blood samples. The two fasting blood samples were averaged to provide one baseline glucose concentration.

The incremental area under each two-hour plasma glucose curve (iAUC) was then calculated in order to obtain a single number, which expresses the total increase in plasma glucose in that subject as a result of ingesting that food during the two-hour period. A GI value for each test product was then calculated for each subject by dividing their two-hour blood glucose iAUC values for each test food by their average two-hour blood glucose iAUC value for the reference food and multiplying by 100 to obtain a percentage value (equation 1). Due to differences in body weight and metabolism, blood glucose responses to the same food can vary between different people. The use of the reference food to calculate GI values reduces the variation between the subjects' blood glucose results to the same food arising from these natural differences. Therefore, the GI value for the same food varies less between subjects than their glucose AUC values for this food.

$$\begin{matrix}GI value for test food ( \% ) = \frac{Plasma glucose iAUC value of test food}{\begin{matrix}Aveage iAUC value of \\ equal \text{-} carbohydrates portion of reference Food\end{matrix}} & Equation 1 \\ RESULTS AND CONCLUSIONS & \end{matrix}$$

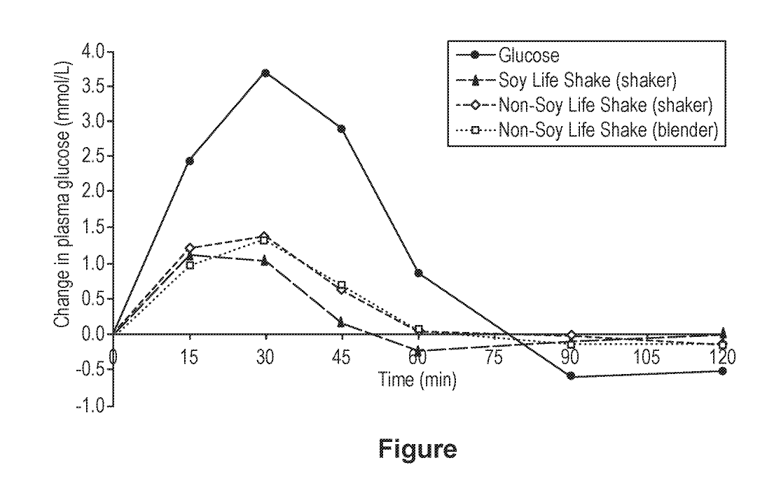

The average two-hour plasma glucose response curves for the 25-gram carbohydrate portions of the reference food and the three prepared Life Shake products are shown in FIG. 1. The reference food was rapidly absorbed, producing a high peak plasma glucose concentration at 30 minutes and the largest overall glycemic response. All three test foods produced substantially lower peak plasma glucose concentrations and overall glycemic responses than the reference food. Different preparation (manual shaking vs. blender mixing) did not affect GI values.

The three shakes prepared with shaker or blender produced average GI values of 26-39, which place these products well within the low GI category (Table 5). Using glucose as the reference food (GI=100), foods with a GI value less than 55 are currently considered to be low-GI foods. Foods with a GI value between 56-69 are medium-GI foods, and foods with a GI value of 70 or more are high-GI foods. Therefore, these shakes would be suitable for consumption in controlled amounts by people with difficulty blood glucose regulation.

TABLE 5
The average ± SEM GI values for the shakes and reference food.

| Test Food | GI Value | GI Category |
|---|---|---|
| Soy Vanilla Life Shake (Shaker) | 26 | Low |
| Non-Soy Vanilla Life Shake (Shaker) | 35 | Low |
| Non-Soy Vanilla Life Shake (Blender) | 39 | Low |
| Reference Food (Glucose) | 100 | High |

GI values are measured using portions of foods and drinks that contain between 25-50 grams of digestible carbohydrate, but these may not be similar to the amounts of these products typically consumed by people in normal environments. It is possible to calculate a glycemic load (GL) value for any sized portion of a carbohydrate-containing food, as long as you know it's GI value. The GL value for a food or drink is calculated according to equation 2 below.

GL value for test foods=(amount of carbohydrate per serving×GI value)/100 Equation 2

Similar to GI values, GL values are useful for helping people identify which types and amounts of foods will produce relatively lower blood glucose responses after consumption—an important consideration for people with diabetes and at risk of developing it. Currently, the consensus is that GL values of 10 or less are low GL; GL values between 11-19 are medium GL values; and GL values of 20 or more are high GL values. The GL values for a standard serve of each of the products tested in this study are listed below:
1. Life Shake Vanilla (Soy) (shaker preparation) (43 g/serving+250 mL water): (12 g Carb×26 GI)/100=3
2. Life Shake Vanilla (Non-Soy) (shaker preparation) (45 g/serving+250 mL water): (12 g Carb×39 GI)/100=5
3. Life Shake Vanilla (Non-Soy) (blender preparation) (45 g/serving+250 mL water): (12 g Carb×35 GI)/100=4
   The three shakes tested in this study produced GL values ranging from 3-5, which places these products in the low GL category. It is therefore clear that the shakes containing the compositions of the invention have a reduced glycemic response despite their overall caloric, sugar and total carbohydrate contents.

Numerous modifications and variations in the practice of the invention are expected to occur to those skilled in the art upon consideration of the presently preferred embodiments thereof. Consequently, the only limitations which should be placed upon the scope of the invention are those which appear in the appended claims.

What is claimed:

1. A composition for use as meal replacement comprising administering to a subject a composition comprising Sacha inchi protein, pea protein, rice protein and potato protein in an amount effective to maintain healthy body weight and lean body mass.

2. The composition of claim 1 wherein the composition comprises from 0.1 to 40 g, or 1 to 30 g, or 2 to 20 g or 5 to 10 g of Sacha inchi protein.

3. The composition of claim 1 wherein the comprises from 0.1 to 40 g, or 1 to 30 g, or 2 to 20 g or 5 to 10 g of pea protein.

4. The composition of claim 1 wherein the composition comprises from 0.1 to 40 g, or 1 to 30 g, or 2 to 20 g or 5 to 10 g of rice protein.

5. The composition of claim 1 wherein the composition is administered comprises from 0.1 to 40 g, or 1 to 30 g, or 2 to 20 g or 5 to 10 g of potato protein.

6. The composition of claim 1 wherein the composition has a PDCAAS protein quality of 0.95 or greater.

7. The composition of claim 1 wherein the composition has a PDCAAS protein quality of 0.98 or greater.

8. The composition of claim 1 wherein the composition has a PDCAAS protein quality of 1.00 or greater.

9. The composition of claim 1 which is provided in a non-beverage food, a beverage, a liquid or a solid dietary supplement.

10. The composition of claim 9 wherein the beverage is a shake.

11. A method of promoting maintenance of healthy body weight, satiety and/or healthy metabolism while maintaining lean body mass in a subject comprising administering to a subject an effective amount of a composition comprising Sacha inchi protein, pea protein, rice protein and potato protein.

12. The method of 11 wherein the composition is administered in an amount containing from 0.1 to 40 g of Sacha inchi protein.

13. The method of 11 wherein the composition is administered in an amount containing from 0.1 to 40 g of pea protein.

14. The method of 11 wherein the composition is administered in an amount containing from 0.1 to 40 g of rice protein.

15. The method of 11 wherein the composition is administered in an amount containing from 0.1 to 40 g of potato protein.

16. The method of claim 11 wherein the composition has a PDCAAS protein quality of 0.95 or greater.

17. The method of claim 11 wherein the composition has a PDCAAS protein quality of 0.98 or greater.

18. The method of claim 11 wherein the composition has a PDCAAS protein quality of 1.00 or greater.

19. The method of claim 11 which is provided in a non-beverage food, a beverage, a liquid or a solid dietary supplement.

20. The method of claim 19 wherein the beverage is a shake.

21. A method of controlling postprandial glycemic response in a mammal comprising the step of feeding the mammal a composition comprising Sacha inchi protein, pea protein, rice protein and potato protein.

22. The method of 21 wherein the composition is administered in an amount containing from 0.1 to 40 g of Sacha inchi protein.

23. The method of 21 wherein the composition is administered in an amount containing from 0.1 to 40 g of pea protein.

24. The method of 21 wherein the composition is administered in an amount containing from 0.1 to 40 g of rice protein.

25. The method of 21 wherein the composition is administered in an amount containing from 0.1 to 40 g of potato protein.

26. The method of claim 21 wherein the composition has a PDCAAS protein quality of 0.95 or greater.

27. The method of claim 21 wherein the composition has a PDCAAS protein quality of 0.98 or greater.

28. The method of claim 21 wherein the composition has a PDCAAS protein quality of 1.00 or greater.

29. The method of claim 21 which is provided in a non-beverage food, a beverage, a liquid or a solid dietary supplement.

30. The method of claim 29 wherein the beverage is a shake.
